(19) United States
(12) Patent Application Publication
(10) Pub. No.: US 2015/0015467 A1
(43) Pub. Date: Jan. 15, 2015

(54) DISPLAY DEVICE AND DRIVING METHOD THEREOF

(71) Applicant: Samsung Display Co., Ltd., Yongin-City (KR)

(72) Inventors: Leonid KAPLAN, Yongin-City (KR); Heung-Yeol NA, Yongin-City (KR); Ho-Ryun CHUNG, Yongin-City (KR); Wang-Jo LEE, Yongin-City (KR); Jang-Doo LEE, Yongin-City (KR)

(73) Assignee: Samsung Display Co., Ltd., Yongin-City (KR)

(21) Appl. No.: 14/095,422

(22) Filed: Dec. 3, 2013

(30) Foreign Application Priority Data
Jul. 9, 2013 (KR) 10-2013-0080554

(51) Int. Cl. G09G 3/32

(52) U.S. Cl. CPC G09G 3/3216
USPC 345/82

(57) ABSTRACT

A display device includes: a unit pixel including subpixels electrically connected to first power voltages and a second power voltage, where the first power voltages include a first first power voltage and a second first power voltage, and where the subpixels include: a first subpixel electrically connected to the first first power voltage and the second power voltage; a second subpixel electrically connected to the second first power voltage and the second power voltage; and a third subpixel electrically connected to the second first power voltage and the second power voltage, where the first power voltage is a voltage having substantially a same level as a voltage, with which the first subpixel emits light at maximum luminance, and the second power voltage is a voltage having substantially a same level as a voltage, with which the second subpixel or the third subpixel emits light at maximum luminance.

This application claims priority to Korean Patent Application No. 10-2013-0080554, filed on Jul. 9, 2013, 2013, and all the benefits accruing therefrom under 35 U.S.C. §119, the content of which in its entirety is herein incorporated by reference.

### BACKGROUND

(a) Field

Exemplary embodiments of the invention relate to a display device and a driving method thereof, and more particularly, to a display device and a driving method thereof with reduced power consumption.

(b) Description of the Related Art

An organic light emitting diode display uses an organic light emitting diode (“OLED”) in which luminance is controlled by a current or a voltage. The OLED includes an anode layer and a cathode layer generating an electric field, and an organic light emitting material emitting light by the electric field.

The OLED may emit light of one of the primary colors. An example of the primary colors may include three primary colors such as red, green and blue, and a predetermined color may be displayed by a spatial summation or temporal summation of the three primary colors.

The OLED emits the light at a luminance corresponding to a current amount flowing from a power source voltage to the OLED. However, a voltage, with which a red organic light emitting diode for emitting red light emits the light at maximum luminance, a voltage, with which a green organic light emitting diode for emitting green light emits the light at maximum luminance, and a voltage with which a blue organic light emitting diode for emitting blue light emits the light at maximum luminance have different levels from each other. Generally, the voltage, with which the red organic light emitting diode emits light at maximum luminance, is highest.

In an organic light emitting diode display, where all the organic light emitting diodes emit the light at maximum luminance, the power source voltages applied to the red organic light emitting diode, the green organic light emitting diode, and the blue organic light emitting diode may be equal to or greater than the voltage with which the red organic light emitting diode emits light at maximum luminance.

### SUMMARY

Exemplary embodiments of the invention relate to a display device and a driving method with reduced power consumption.

According to an exemplary embodiment of the invention, a display device includes: a unit pixel including a plurality of subpixels electrically connected to a plurality of first power voltages and a second power voltage, where the plurality of first power voltages includes a first first power voltage and a second first power voltage, and where the plurality of subpixels includes: a first subpixel electrically connected to the first first power voltage and the second power voltage; a second subpixel electrically connected to the second first power voltage and the second power voltage; and a third subpixel electrically connected to the second first power voltage and the second power voltage, in which the first first power voltage is a voltage having substantially a same level as a voltage, with which the first subpixel emits light at maximum luminance, and the second first power voltage is a voltage having substantially a same level as a voltage, with which the second subpixel or the third subpixel emits the light at maximum luminance

In an exemplary embodiment, the voltage, with which the second subpixel or the third subpixel emits the light at maximum luminance, may be the greater voltage of a voltage, with which the second subpixel emits light at maximum luminance and a voltage, with which the third subpixel emits the light at maximum luminance.

In an exemplary embodiment, the power voltage may be zero (0) volt (V).

In an exemplary embodiment, the first subpixel may be a blue subpixel which emits blue light, the second subpixel may be a red subpixel which emits red light, and the third subpixel may be a green subpixel which emits green light.

In an exemplary embodiment, the first first power voltage may be a voltage having substantially a same level as a voltage, with which the blue subpixel emits the blue light at maximum luminance, and the second first power voltage may be a voltage having substantially a same level as a voltage, with which the red subpixel emits the red light at maximum luminance.

In an exemplary embodiment, the first subpixel may be a red subpixel which emits red light, the second subpixel may be a green subpixel which emits green light, and the third subpixel may be a blue subpixel which emits blue light.

In an exemplary embodiment, the first first power voltage may be a voltage having substantially a same level as a voltage, with which the red subpixel emits the red light at maximum luminance, and the second first power voltage may be a voltage having substantially a same level as a voltage, with which the green subpixel emits the green light at maximum luminance.

In an exemplary embodiment, the first subpixel may be a green subpixel which emits green light, the second subpixel may be a red subpixel which emits red light, and the third subpixel may be a blue subpixel which emits blue light.

In an exemplary embodiment, the first first power voltage may be a voltage having substantially a same level as a voltage, with which the green subpixel emits the green light at maximum luminance, and the second first power voltage may be a voltage having substantially a same level as a voltage, with which the red subpixel emits the red light at maximum luminance.

Another exemplary embodiment of the invention provides a driving method of a display device, including: emitting light from a first subpixel of a unit pixel of the display device using a first first power voltage and a second power voltage; emitting light from a second subpixel of the unit pixel using a second first power voltage and the first power voltage; and emitting light from a third subpixel of the unit pixel using the second first power voltage and the first power voltage, in which the first first power voltage is a voltage having substantially a same level as a voltage, with which the first subpixel emits light at maximum luminance, the second first power voltage is a voltage having substantially a same level as a voltage, with which the second subpixel or the third subpixel emits the light at maximum luminance.

In an exemplary embodiment, the second power voltage may be about zero (0) V.

In an exemplary embodiment, the first subpixel may be a blue subpixel which emits blue light, the second subpixel may be a red subpixel which emits red light, and the third subpixel may be a green subpixel which emits green light.

In an exemplary embodiment, the first first power voltage may be a voltage having substantially a same level as a voltage, with which the blue subpixel emits the blue light at maximum luminance, and the second first power voltage may be a voltage having substantially a same level as a voltage, with which the red subpixel emits the red light at maximum luminance.

In an exemplary embodiment, the first subpixel may be a red subpixel which emits red light, the second subpixel may be a green subpixel which emits green light, and the third subpixel may be a blue subpixel which emits blue light.

In an exemplary embodiment, the first first power voltage may be a voltage having substantially a e same level as a voltage, with which the red subpixel emits the red light at maximum luminance, and the second first power voltage may be a voltage having substantially a same level as a voltage, with which the green subpixel emits the green light at maximum luminance.

In an exemplary embodiment, the first subpixel may be a green subpixel which emits green light, the second subpixel may be a red subpixel which emits red light, and the third subpixel may be a blue subpixel which emits blue light.

In an exemplary embodiment, the first first power voltage may be a voltage having substantially a same level as a voltage, with which the green subpixel emits the green light at maximum luminance, and the second first power voltage may be a voltage having substantially a same level as a voltage, with which the red subpixel emits the red light at maximum luminance.

According to exemplary embodiments of the invention, power consumption is substantially reduced, while a wire structure of a display device is substantially simplified.

### BRIEF DESCRIPTION OF THE DRAWINGS

The above and other features of the invention will become more apparent by describing in detail exemplary embodiments thereof with reference to the attached drawings, in which:

FIG. 1 is a block diagram illustrating an exemplary embodiment of a display device according to the invention;

FIG. 2 is a circuit diagram illustrating a pixel of an exemplary embodiment of a display device according to the invention; and

FIG. 3 is a circuit diagram illustrating a connection of first power source voltages and a second power source voltage with a unit pixel in an exemplary embodiment of a display device according to the invention.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

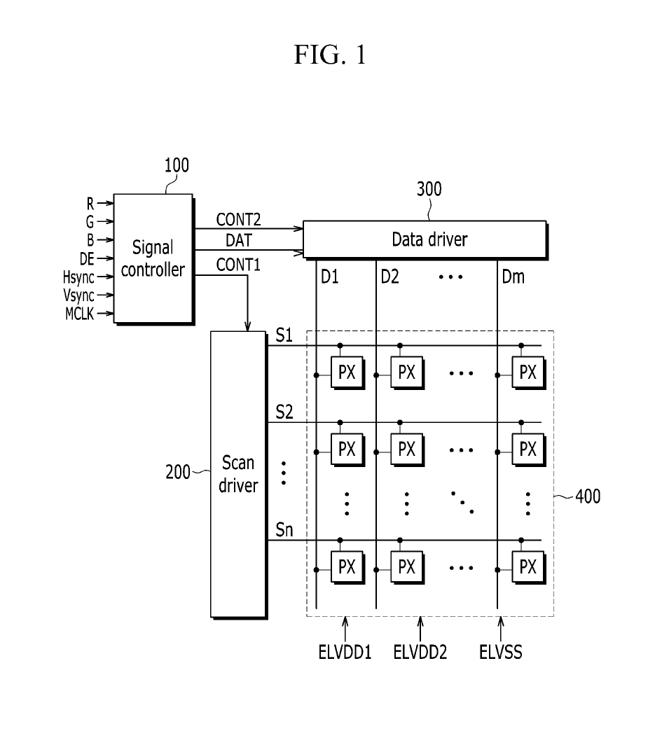

FIG. 1 is a block diagram illustrating an exemplary embodiment of a display device according to the invention.

Referring to FIG. 1, an exemplary embodiment of the display device includes a signal controller 100, a scan driver 200, a data driver 300 and a display unit 400.

The signal controller 100 receives image signals R, G and B from an external device, and an input control signal for controlling display of the image signals R, G and B. The image signals R, G and B include luminance information of each pixel PX for displaying an image, and luminance has a predetermined number of grayscale levels, for example, 1024 (=2¹⁰), 256 (=2⁸), or 64 (=2⁶) grayscale levels. In an exemplary embodiment, the input control signal includes a data enable signal DE, a horizontal synchronizing signal Hsync, a vertical synchronization signal Vsync, a main clock MCLK, and the like.

The signal controller 100 processes the input image signals R, G and B in accordance with operation conditions of the display unit 400 and the data driver 300 based on the input image signals R, G and B and the input control signal, and the signal controller 100 generates a scan control signal CONT1, a data control signal CONT2, and an image data signal DAT. The signal controller 100 transfers the scan control signal CONT1 to the scan driver 200. The signal controller 100 transfers the data control signal CONT2 and the image data signal DAT to the data driver 300.

The display unit 400 includes a plurality of scan lines S1-Sn, a plurality of data lines D1-Dm, and a plurality of subpixels PX. Here, each of n and m is a natural number equal to or greater than 2. The plurality of subpixels PX is arranged substantially in a matrix form and connected to the plurality of scan lines S1-Sn and the plurality of data lines D1-Dm. The plurality of scan lines S1-Sn extends substantially in a row direction and is disposed substantially parallel to each other. The plurality of data lines D1-Dm extends substantially in a column direction and is disposed substantially parallel to each other. Each of the plurality of subpixels PX receives one of a plurality of first power voltages ELVDD1 and ELVDD2, and a second power voltage ELVSS from the outside. In such an embodiment, as shown in FIG. 1, the plurality of first power voltages may include a first first power voltage ELVDD1 and a second first power voltage ELVDD2. The scan driver 200 is connected to the plurality of scan lines S1-Sn, and applies a scan signal including a gate-on voltage and a gate-off voltage to the plurality of scan lines S1-Sn based on the scan control signal CONT1.

The data driver 300 is connected to the plurality of data lines D1-Dm, and selects a grayscale voltage based on the image data signal DAT. The data driver 300 applies the grayscale voltage selected based on the data control signal CONT2 to the plurality of data lines D1-Dm as a data signal.

In an exemplary embodiment, each of the signal controller 100, the scan driver 200 and the data driver 300 may be disposed, e.g., installed, outside of a pixel area and may be in an integrated circuit (“IC”) chip form, installed on a flexible printed circuit film. In an alternative exemplary embodiment, each of the signal controller 100, the scan driver 200 and the data driver 300 may be attached to the display unit 400 in a tape carrier package (“TCP”) form, installed on a separate printed circuit board, or integrated outside of the pixel area together with the plurality of scan lines S1-Sn and the plurality of data lines D1-Dm.

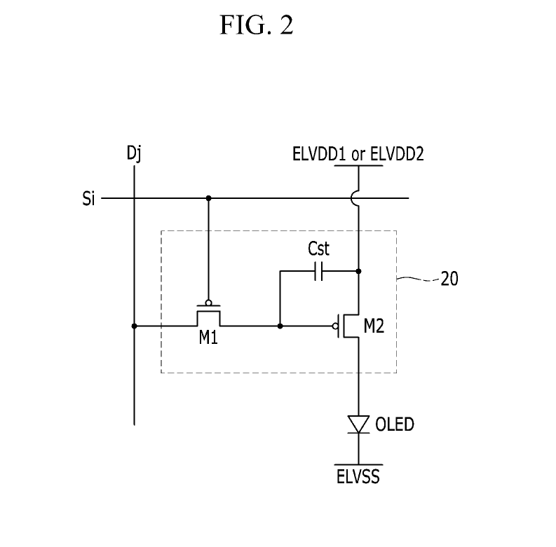

FIG. 2 is a circuit diagram illustrating a subpixel of an exemplary embodiment of the organic light emitting diode display according to the invention.

Referring to FIG. 2, a subpixel of an exemplary embodiment of the organic light emitting diode display includes an organic light emitting diode (“OLED”) and a pixel circuit 20 for controlling the OLED. The pixel circuit 20 includes a switching transistor M1, a driving transistor M2 and a storage capacitor Cst.

In an exemplary embodiment, as shown in FIG. 2, the pixel circuit 20 may include two transistors M1 and M2 and one capacitor Cst, but not being limited thereto. In an alternative exemplary embodiment, the pixel circuit of the organic light emitting diode display may be variously configured to operate.

The switching transistor M1 includes a gate electrode connected to a corresponding scan line Si of the plurality of scan lines S1-Sn, one electrode connected to a corresponding data line Dj of the plurality of data lines D1-Dm, and the other electrode connected to a gate electrode of the driving transistor M2, where T is a natural number equal to or less than n, and T is a natural number equal to or less than m.

The driving transistor M2 includes a gate electrode connected to the other electrode of the switching transistor M1, one electrode connected to the first first power voltage ELVDD1 or the second first power voltage ELVDD2, and the other electrode connected to an anode of the OLED.

The storage capacitor Cst includes one electrode connected to the first first power voltage ELVDD1 or the second first power voltage ELVDD2, and the other electrode connected to the gate electrode of the driving transistor M2. The storage capacitor Cst charges a data voltage applied to the gate electrode of the driving transistor M2 and maintains the charged data voltage after the switching transistor Qs is turned off.

The OLED includes the anode connected to the other electrode of the driving transistor M2, and a cathode connected to the second power voltage ELVSS. The OLED may emit light of one of the primary colors. In one exemplary embodiment, for example, the primary colors may include three primary colors such as red, green and blue, and a predetermined color may be displayed by a spatial summation or a temporal summation of the three primary colors.

In an exemplary embodiment, the subpixel may be classified into a plurality of subpixels based on the color of the light emitted therefrom, e.g., a red subpixel that emits red light, a green subpixel that emits green light and a blue subpixel that emits blue light. A unit pixel may be collectively defined by the red subpixel, the green subpixel and the blue subpixel.

An organic light emitting layer of the OLED may include a low-molecular organic material or a high-molecular organic material such as poly 3,4-ethylenedioxythiophene (“PEDOT”), for example. In an exemplary embodiment, the organic light emitting layer may have a multi-layer structure including a light emitting layer, and at least one of a hole injection layer (“HIL”), a hole transporting layer (“HTL”), an electron transporting layer (“ETL”) and an electron injection layer (“EIL”). In one exemplary embodiment, for example, the organic light emitting layer includes the light emitting layer, the HIL, the HTL, the ETL and EIL, where the HIL is disposed on a pixel electrode which is an anode, and the HTL, the light emitting layer, the ETL and the EIL are sequentially disposed, e.g., laminated, on the HIL.

The organic light emitting layer may include a red organic light emitting layer that emits red light, a green organic light emitting layer that emits green light, or a blue organic light emitting layer that emits blue light. In an exemplary embodiment, the red subpixel, the green subpixel and the blue subpixel include the red organic light emitting layer, the green organic light emitting layer and the blue organic light emitting layer, respectively, such that a color image is display by the unit pixel, which is collectively defined by the red, green and blue subpixels.

In an alternative exemplary embodiment, each of the red subpixel, the green subpixel and the blue subpixel may include an organic light emitting layer including the red organic light emitting layer, the green organic light emitting layer and the blue organic light emitting layer, which may be stacked on one another, and a red color filter, a green color filter and a blue color filter are provided for the red, green and blue subpixels, respectively, such that a color image is displayed by the unit pixel, which is collectively defined by the red, green and blue subpixels.

In an alternative exemplary embodiment, each of the red subpixel, the green subpixel and the blue subpixel includes a white organic light emitting layer that emits white light, and the red color filter, the green color filter and the blue color filter are provided for the red, green and blue subpixels, respectively, such that a color image is displayed by the unit pixel, which is collectively defined by the red, green and blue subpixels. In such an embodiment, where each of the red subpixel, the green subpixel and the blue subpixel includes the white organic light emitting layer, the red subpixel, the green subpixel and the blue subpixel may be provided without using a deposition mask for depositing the red organic light emitting layer, the green organic light emitting layer or the blue organic light emitting layer on the red subpixel, the green subpixel or the blue subpixel.

In an exemplary embodiment, where each of the red subpixel, the green subpixel and the blue subpixel includes the white organic light emitting layer, the white organic light emitting layer may have a single layer structure, or a multi-layer structure. In one exemplary embodiment, for example, the white organic light emitting layer, which emits white light, may have a multi-layer structure including a yellow organic light emitting layer and a blue light emitting layer, a multi-layer structure including a cyan organic light emitting layer and a red light emitting layer, or a multi-layer structure including a magenta organic light emitting layer and a green light emitting layer, and the like.

In an exemplary embodiment, the switching transistor M1 and the driving transistor M2 may be p-channel field effect transistors. In such an embodiment, a gate-on voltage for turning on the switching transistor M1 and the driving transistor M2 is a low level voltage, and a gate-off voltage for turning off the switching transistor M1 and the driving transistor M2 is a high level voltage.

In an alternative exemplary embodiment, at least one of the switching transistor M1 and the driving transistor M2 may be an n-channel field effect transistor. In such an embodiment, a gate-on voltage for turning on the n-channel field effect transistor is a high level voltage, and a gate-off voltage for turning off the n-channel field effect transistor is a low level voltage.

At least one of the switching transistor M1 and the driving transistor M2 may be an oxide thin film transistor (“Oxide TFT”), in which a semiconductor layer includes an oxide semiconductor.

In an exemplary embodiment, the oxide semiconductor may include one of oxide based on titanium (Ti), hafnium (Hf), zirconium (Zr), aluminum (Al), tantalum (Ta), germanium (Ge), zinc (Zn), gallium (Ga), tin (Sn) or indium (In), zinc oxide (ZnO), indium-gallium-zinc oxide (InGaZnO4), indium-zinc oxide (Zn—In—O), zinc-tin oxide (Zn—Sn—O) indium-gallium oxide (In—Ga—O), indium-tin oxide (In—Sn—O), indium-zirconium oxide (In—Zr—O), indium-zirconium-zinc oxide (In—Zr—Zn—O) indium-zirconium-tin oxide (In—Zr—Sn—O), indium-zirconium-gallium oxide (In—Zr—Ga—O), indium-aluminum oxide (In—Al—O), indium-zinc-aluminum oxide (In—Zn—Al—O), indium-tin-aluminum oxide (In—Sn—Al—O), indium-aluminum-gallium oxide (In—Al—Ga—O), indium-tantalum oxide (In—Ta—O), indium-tantalum-zinc oxide (In—Ta—Zn—O), indium-tantalum-tin oxide (In—Ta—Sn—O), indium-tantalum-gallium oxide (In—Ta—Ga—O), indium-germanium oxide (In—Ge—O), indium-germanium-zinc oxide (In—Ge—Zn—O), indium-germanium-tin oxide (In—Ge—Sn—O), indium-germanium gallium oxide (In—Ge—Ga—O), titanium-indium-zinc oxide (Ti—In—Zn—O), or hafnium-indium-zinc oxide (Hf—In—Zn—O), which are complex oxides thereof.

The semiconductor layer includes a channel region, in which an impurity is not doped, and a source and drain regions, which are provided, e.g., formed, when impurities are doped to two sides of the channel region. In an exemplary embodiment, the impurity varies according to a kind of the thin film transistor. In an exemplary embodiment, the impurity may be an N-type impurity or a P-type impurity.

In an exemplary embodiment, where the semiconductor layer includes an oxide semiconductor, a separate passivation layer may be provided to protect the oxide semiconductor, which may be vulnerable to an external environment, e.g., a high temperature environment.

An operation of an exemplary embodiment of the subpixel will be hereinafter described.

When the scan signal of the gate-on voltage is applied to the scan line Si, the switching transistor M1 is turned on, and the data signal applied to the data line Dj is applied to the other electrode of the storage capacitor Cst to charge the storage capacitor Cst. The driving transistor M2 controls a current amount which flows from the first first power voltage ELVDD1 or the second first power voltage ELVDD2 to the OLED in response to the voltage charged in the storage capacitor Cst. A current flowing through the driving transistor M2 from the first first power voltage ELVDD1 or the second first power voltage ELVDD2 flows into the OLED. The ‘OLED generates light corresponding to the current amount flowing through the driving transistor M2.

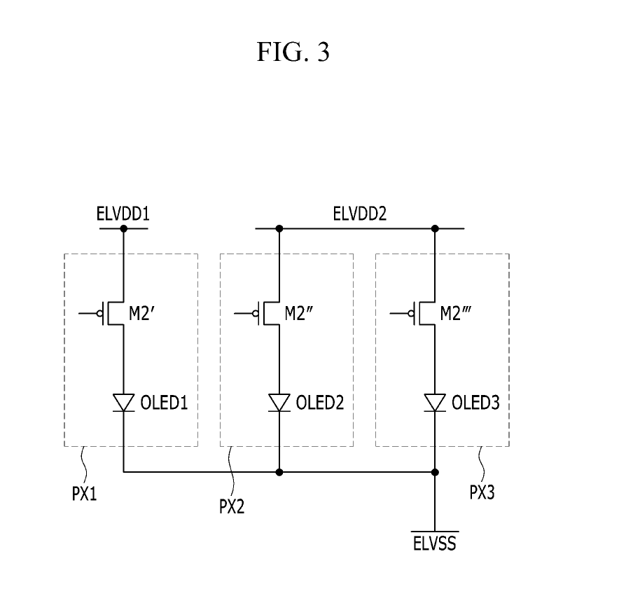

Hereinafter, a unit pixel including a red subpixel, a green subpixel and a blue subpixel, is connected to the first first power voltage ELVDD1, the second first power voltage ELVDD2, and the second power voltage ELVSS will be described with reference to FIG. 3.

FIG. 3 is a circuit diagram illustrating a connection of the first first power voltage, the second first power voltage, and the second power voltage in an exemplary embodiment of a display device according to the invention.

In FIG. 3, for convenience of illustration, a driving transistor M2′ and an organic light emitting diode OLED1 of a first subpixel PX1 of a unit pixel, a driving transistor M2″ and an organic light emitting diode OLED2 of a second subpixel PX2 of the unit pixel, and a driving transistor M2′″ and an organic light emitting diode OLED3 of a third subpixel PX3 of the unit pixel in an exemplary embodiment of a display device are illustrated.

In such an embodiment, the first subpixel PX1, the second subpixel PX2 and the third subpixel PX3 collectively define the unit pixel.

In an exemplary embodiment, as shown in FIG. 3, the first subpixel PX1 is electrically connected to the first first power voltage ELVDD1 and the second power voltage ELVSS. The second subpixel PX2 is electrically connected to the second first power voltage ELVDD2 and the second power voltage ELVSS. The third subpixel PX3 is electrically connected to the second first power voltage ELVDD2 and the second power voltage ELVSS.

In such an embodiment, the first subpixel PX1 emits light using the first first power voltage ELVDD1 and the second power voltage ELVSS. In such an embodiment, the second subpixel PX2 emits light using second first power voltage ELVDD2 and the second power voltage ELVSS. In such an embodiment, the third subpixel PX3 emits light using the second first power voltage ELVDD2 and the second power voltage ELVSS.

In one exemplary embodiment, for example, the power voltage may be about zero (0) volt (V).

In an exemplary embodiment, the first power voltage ELVDD1 is a voltage having substantially the same level as the voltage for emitting the light of the first subpixel PX1 at maximum luminance. In such an embodiment, when a data signal having a maximum grayscale is applied to the gate electrode of the driving transistor M2′ of the first subpixel PX1, the first power voltage ELVDD1 is determined as a voltage for generating a current amount, with which the organic light emitting diode OLED1 emits the light at maximum luminance.

In an exemplary embodiment, the second power voltage ELVDD2 is a voltage having substantially the same level as the voltage, with which the second subpixel PX2 or the third subpixel PX3 emits the light at maximum luminance. In such an embodiment, the second power voltage ELVDD2 is a voltage having substantially the same level as a high level in the voltage with which the second subpixel PX2 emits the light at maximum luminance, or the voltage with which the third subpixel PX3 emits the light at maximum luminance.

In an exemplary embodiment, where the unit pixel includes the red, green and blue subpixels, when the voltage with which the red subpixel emits the light at maximum luminance is denoted by VR, the voltage with which the green subpixel emits the light at maximum luminance is denoted by VG, and the voltage with which the blue subpixel emits the light at maximum luminance is denoted by VB, is the voltages satisfy the following inequation: VR>VG>VB. In one exemplary embodiment, for example, when the second power voltage is about zero (0) V, VR may be about 7.6 V, VG may be about 6.6 V, and VB may be about 5.0 V.

Accordingly, in an exemplary embodiment, where the second subpixel PX2 or the third subpixel PX3 corresponds to any one of the red subpixel, the green subpixel and the blue subpixel, the second first power voltage ELVDD2 may be determined to any one of VR and VG.

In an exemplary embodiment, the first subpixel PX1 may be a blue subpixel that emits blue light, the second subpixel PX2 may be a red subpixel that emits red light, and the third subpixel PX3 may be a green subpixel that emits green light. In such an embodiment, the first power voltage ELVDD1 becomes a voltage having substantially the same level as a voltage VB with which the blue subpixel emits the light at maximum luminance, and the second power voltage ELVDD2 becomes a voltage having substantially the same level as a voltage VR with which the red subpixel emits the light at maximum luminance. In such an embodiment, the second power voltage may be about zero (0) V.

In an alternative exemplary embodiment, the first subpixel PX1 may be a red subpixel that emits red light, the second subpixel PX2 may be a green subpixel that emits green light, and the third subpixel PX3 may be a blue subpixel that emits blue light. In such an embodiment, the first power voltage ELVDD1 becomes a voltage having substantially the same level as a voltage VR with which the red subpixel emits the light at maximum luminance, and the second power voltage ELVDD2 becomes a voltage having substantially the same level as a voltage VG with which the green subpixel emits the light at maximum luminance. In such an embodiment, the power voltage may be about zero (0) V.

In another alternative exemplary embodiment, the first subpixel PX1 may be a green subpixel that emits green light, the second subpixel PX2 may be a red subpixel that emits red light, and the third subpixel PX3 may be a blue subpixel that emits blue light. In such an embodiment, the first power voltage ELVDD1 becomes a voltage having substantially the same level as a voltage VG with which the green subpixel emits the light at maximum luminance, and the second power voltage ELVDD2 becomes a voltage having substantially the same level as a voltage VR with which the red subpixel emits the light at maximum luminance. In such an embodiment, the power voltage may be about zero (0) V.

In a display device, a single first power voltage and a single second power voltage are connected to each unit pixel. In such a display device, the first power voltage and the second power voltage are connected to the red subpixel, the green subpixel and the blue subpixel. In such a display device, the power voltage is typically determined as a voltage of the voltage VR or more with which the red subpixel emits the light at maximum luminance. In such a display device, unnecessary voltages are applied to the green subpixel and the blue subpixel such that unnecessary power consumption may occur.

In a display device, a separate power voltage may be connected to each of the three subpixels included in a unit pixel. In such a display device, the first power voltage of the voltage VR having substantially the same level as the voltage with which the red subpixel emits the light at maximum luminance may be connected to the red subpixel, the second power voltage of the voltage VG having substantially the same level as the voltage with which the green subpixel emits the light at maximum luminance may be connected to the green subpixel, and the third power voltage of the voltage VB having substantially the same level as the voltage with which the blue subpixel emits the light at maximum luminance may be connected to the blue subpixel. In such a display device, unnecessary power consumption may be removed by effectively preventing unnecessary voltages from being applied to the red subpixel, the green subpixel and the blue subpixel. However, in such an embodiment, four power wires are provided to drive the subpixels such that a wire structure of the display device may be substantially complicated and a yield may be substantially reduced during a production process.

As described above, in an exemplary embodiment of the first first power voltage ELVDD1 and the power voltage are connected to the first subpixel PX1, the second first power voltage ELVDD2, and the second power voltage ELVSS are connected to the second subpixel PX2 and the third subpixel PX3, such that the power consumption is substantially reduced and the wire structure of the display device is substantially simplified.

Hereinafter, power consumption of a display device in which a single first power voltage and a single second power voltage are connected to each of the three subpixels, power consumption in a display device, where a pixel in which a separate power voltage is connected to each of the three subpixels, and power consumption in the exemplary embodiments of a unit pixel described above will be described in detail.

The power reduction amount in the unit pixel of the display device in which a separate first power voltage is connected to each of the three subpixels may be represented by the following Equation 1.

ΔP=(VR−VG)×IG+(VR−VB)×IB Equation 1:

Here, ΔP denotes a power reduction amount, VR denotes a voltage with which a red subpixel emits light at maximum luminance, VG denotes a voltage with which a green subpixel emits light at maximum luminance, VB denotes a voltage with which a blue subpixel emits light at maximum luminance, IG denotes a current amount which flows into an OLED of the green subpixel to emit light at maximum luminance, and IB denotes a current amount which flows into an OLED of the blue subpixel to emit light at maximum luminance.

The power reduction amount in the unit pixel of an exemplary embodiment, where the first subpixel PX1 is the blue subpixel, the second subpixel PX2 is the red subpixel and the third subpixel PX3 is the green subpixel (hereinafter, a first exemplary embodiment), may be represented by the following Equation 2.

ΔP=(VR−VB)×IB Equation 2:

The power reduction amount in the unit pixel of an exemplary embodiment, where the first subpixel PX1 is the red subpixel, the second subpixel PX2 is the green subpixel and the third subpixel PX3 is the blue subpixel (hereinafter, a second exemplary embodiment), may be represented by the following Equation 3.

ΔP=(VR−VG)×(IG+IB) Equation 3:

The power reduction amount in the unit pixel of an exemplary embodiment, where the first subpixel PX1 is the green subpixel, the second subpixel PX2 is the red subpixel and the third subpixel PX3 is the blue subpixel (hereinafter, a third exemplary embodiment), may be represented by the following Equation 4.

ΔP=(VR−VG)×IG Equation 4:

The power reduction amounts in the unit pixel of the display device in which a separate first power voltage is connected to each of the three subpixels, the unit pixel of the first exemplary embodiment, the unit pixel of the second exemplary embodiment, and the unit pixel of the third exemplary embodiment were measured when VR is about 7.6 V, VG is about 6.6 V, VB is about 5.0 V, IR is about 2.97 microamperes (μA), IG is about 4.35 μA, and IB is about 10.7 μA. The power reduction amount in the unit pixel in which a separate power voltage is connected to each of the three subpixels is about 32.17 microwatts (μW), the power reduction amount in the unit pixel of the first exemplary embodiment is about 27.82 μW, the power reduction amount in the unit pixel of the second exemplary embodiment is about 15.05 μW, and the power reduction amount in the unit pixel of the third exemplary embodiment is about 4.35 μW. As compared with the power reduction amount in the unit pixel of the display device in which a separate power voltage is connected to each of the three subpixels, the power reduction amount in the unit pixel of the first exemplary embodiment is about 86.48%, the power reduction amount in the unit pixel of the second exemplary embodiment is about 46.78%, and the power reduction amount in the unit pixel of the third exemplary embodiment is about 13.52%.

The power reduction amount in the unit pixel of the first exemplary embodiment is less than the power reduction in the unit pixel of the display device in which a separate power voltage is connected to each of the three subpixels by only about 13.52%, while the number of power wires is substantially reduced. As described above, in an exemplary embodiment, power consumption is substantially reduced, while the wire structure of the display device is substantially simplified.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a unit pixel comprising a plurality of subpixels electrically connected to a plurality of first power voltages and a second power voltage,
wherein the plurality of first power voltages comprises a first first power voltage and a second first power voltage, and
wherein the plurality of subpixels comprises:
a first subpixel electrically connected to the first first power voltage and the second power voltage;
a second subpixel electrically connected to the second first power voltage and the second power voltage; and
a third subpixel electrically connected to the second first power voltage and the second power voltage,
wherein the first first power voltage is a voltage having substantially a same level as a voltage, with which the first subpixel emits light at maximum luminance, and the second first power voltage is a voltage having substantially a same level as a voltage, with which the second subpixel or the third subpixel emits light at maximum luminance.

2. The display device of claim 1, wherein
the voltage, with which the second subpixel or the third subpixel emits the light at maximum luminance, is the greater voltage of a voltage, with which the second subpixel emits light at maximum luminance, and a voltage, with which the third subpixel emits light at maximum luminance.

3. The display device of claim 1, wherein
the second power voltage is about zero volt.

4. The display device of claim 1, wherein
the first subpixel is a blue subpixel which emits blue light,
the second subpixel is a red subpixel which emits red light, and
the third subpixel is a green subpixel which emits green light.

5. The display device of claim 4, wherein
the first first power voltage is a voltage having substantially a same level as a voltage, with which the blue subpixel emits the blue light at maximum luminance, and
the second first power voltage is a voltage having substantially a same level as a voltage, with which the red subpixel emits the red light at maximum luminance.

6. The display device of claim 1, wherein
the first subpixel is a red subpixel which emits red light,
the second subpixel is a green subpixel which emits green light, and
the third subpixel is a blue subpixel which emits blue light.

7. The display device of claim 6, wherein
the first first power voltage is a voltage having substantially a same level as a voltage, with which the red subpixel emits the red light at maximum luminance, and
the second first power voltage is a voltage having substantially a same level as a voltage, with which the green subpixel emits the green light at maximum luminance.

8. The display device of claim 1, wherein
the first subpixel is a green subpixel which emits green light,
the second subpixel is a red subpixel which emits red light, and
the third subpixel is a blue subpixel which emits blue light.

9. The display device of claim 8, wherein
the first first power voltage is a voltage having substantially a same level as a voltage, with which the green subpixel emits the green light at maximum luminance, and
the second first power voltage is a voltage having substantially a same level as a voltage, with which the red subpixel emits the red light at maximum luminance.

10. A driving method of a display device, the method comprising:
emitting light from a first subpixel of a unit pixel of the display device using a first first power voltage and a second power voltage;
emitting light from a second subpixel of the unit pixel using a second first power voltage and the second power voltage; and
emitting light from a third subpixel of the unit pixel using the second first power voltage and the second power voltage;
wherein the first first power voltage is a voltage having substantially a same level as a voltage, with which the first subpixel emits light at maximum luminance, and the second first power voltage is a voltage having substantially a same level as a voltage, with which the second subpixel or the third subpixel emits the light at maximum luminance.

11. The driving method of a display device of claim 10, wherein
the second power voltage is about zero volt.

12. The driving method of a display device of claim 10, wherein
the voltage, with which the second subpixel or the third subpixel emits the light at maximum luminance, is the greater voltage of a voltage, with which the second subpixel emits light at maximum luminance, and a voltage, with which the third subpixel emits light at maximum luminance

13. The driving method of a display device of claim 10, wherein
the first subpixel is a blue subpixel which emits blue light,
the second subpixel is a red subpixel which emits red light, and
the third subpixel is a green subpixel which emits green light.

14. The driving method of a display device of claim 13, wherein
the first first power voltage is a voltage having substantially a same level as a voltage, with which the blue subpixel emits the blue light at maximum luminance, and
the second first power voltage is a voltage having substantially a same level as a voltage, with which the red subpixel emits the red light at maximum luminance.

15. The driving method of a display device of claim 10, wherein
the first subpixel is a red subpixel which emits red light,
the second subpixel is a green subpixel which emits green light, and
the third subpixel is a blue subpixel which emits blue light.

16. The driving method of a display device of claim 15, wherein
the first first power voltage is a voltage having substantially a same level as a voltage, with which the red subpixel emits the red light at maximum luminance, and
the second first power voltage is a voltage having substantially a same level as a voltage, with which the green subpixel emits the green light at maximum luminance.

17. The driving method of a display device of claim 10, wherein
the first subpixel is a green subpixel which emits green light,
the second subpixel is a red subpixel which emits red light, and
the third subpixel is a blue subpixel which emits blue light.

18. The driving method of a display device of claim 17, wherein
the first first power voltage is a voltage having substantially a same level as a voltage, with which the green subpixel emits the green light at maximum luminance, and
the second first power voltage is a voltage having substantially a same level as a voltage, with which the red subpixel emits the red light at maximum luminance.
